(19) United States
(12) Patent Application Publication
(10) Pub. No.: US 2003/0140903 A1
(43) Pub. Date: Jul. 31, 2003

(54) Electronic combustion enhancer and system

(76) Inventor: James Paul Smoot, Virginia Beach, VA (US)

Correspondence Address: BRADLEY D. GOLDIZEN, PENDER & COWARD P.C., 192 BALLARD COURT, SUITE 400, VIRGINIA, VA, 23462, US

(21) Appl. No.: 10/055,152

(22) Filed: Jan. 25, 2002

(51) Int. Cl. F02M 27/00

(52) U.S. Cl. 123/538

(57) ABSTRACT

The invention is a fuel treatment system that enhances fuel combustion by ionizing hydrocarbons in the fuel to exhibit a net positive charge thereby causing oxygen to more readily combine with the hydrocarbons. A modulated RF and harmonic frequency generator emits a controlled signal to a coil provided around a fuel supply line to ionize and overcome the thixotropy of the hydrocarbons. The ionized hydrocarbons readily combine with oxygen molecules to provide a more complete burning of fuel in the combustion chamber. The system comprises removing particulate matter and free water from fuel, treating the fuel with a catalyst, ionizing the fuel via an electronic combustion enhancer, aligning molecules in the fuel with a magnet, and reducing engine friction with a friction reducing metal conditioner.

### CROSS-REFERENCE TO RELATED APPLICATIONS

This patent application relates to provisional patent application No. 60/125,318 filed on Dec. 6, 2000 and claims priority therefrom.

### BACKGROUND OF THE INVENTION

This invention pertains to a fuel enhancing system that increases the realized energy output or efficiency of an internal combustion engine. More particularly, the present invention relates to an apparatus and method for treating fuel before passing it into a combustion chamber.

Several known methods for increasing the performance of an internal combustion engine exist. These methods include electromechanical conditioning of the fuel, or additives such as catalysts and filters that tend to boost the octane or clean the fuel before combustion of the fuel occurs. Several of these methods reduce pollutants emitted into the atmosphere.

U.S. Pat. No. 4,716,024 to Pera relates to an improved apparatus for treating fluids such as organic fuels. Several annular-shaped permanent magnets are arranged in a side-by-side spaced relationship within a housing and may be installed within a fuel line immediately upstream of a carburetor or fuel injection port. Fuel is caused to flow into, through and out of the apparatus before being vaporized or atomized.

U.S. Pat. No. 4,986,907 to Montemayor Uzeta teaches a fuel purifying apparatus that is placed between a fuel storage tank and the primary filter of an automobile for refining diesel fuel by separating the fuel from impurities such as water, oxides, sulfur, etc. After entering the apparatus, fuel is forced against a preheated metal plate to create a turbulence that facilitates separation of the impurities from the fuel.

U.S. Pat. No. 5,487,370 to Miyazki discloses an improved apparatus that is disposed between a fuel tank and an engine to magnetically process fuel oil and feed it into the combustion system. The apparatus includes a plurality of annular permanent magnets fixedly disposed in a cylindrical casing. The magnets are arranged in close contact with one another in series, repulsive relationship to each other.

U.S. Pat. No. 5,667,677 to Stefanini teaches an apparatus for and a method of, treating a fluid. A microphone, for detecting turbulence created when water passes over scale deposits, is positioned in physical contact with a pipe that carries water. The microphone produces an analog signal, having a frequency proportional to the amount of turbulence detected. The analog signal is filtered, processed, amplified and shaped into a series of radio frequency signals having a random wait state between each signal.

Fuel, such as gasoline and diesel, is typically composed of large chain hydro-carbons that do not combine well with oxygen during a burn cycle of a combustion engine. Thus, incomplete combustion occurs during the burn process. Incomplete combustion of fuel results in a lower fuel economy for the engine and an increase of pollutants into the atmosphere. Reducing the amount of incomplete combustion occurring during a burn cycle reduces harmful exhaust emissions such as hydrocarbons (HC), carbon monoxide (CO) and nitrogen oxide (NOₓ), thereby creating a cleaner environment.

Thixotrophy is a property of some fuels that contributes to an incomplete combustion process. Thixotropic materials are gel-like at rest and fluid-like when agitated. Diesel fuel is a type of thixotropic material. Thus, the fuel tries to assume a solid state when it is at rest. Moreover, diesel fuel tends to stiffen or gel in cold temperatures. However, the fuel will return to a liquid state if it is manipulated or agitated. The present invention recognizes that diesel fuel burns more efficiently if it is first agitated.

### BRIEF SUMMARY OF THE INVENTION

Hydrocarbon fuels used in automobiles and trucks leave a natural deposit of residue that tends to clog carburetors and fuel injectors thereby reducing efficiency and wasting fuel. Pinging, stalling, loss of horsepower and decreased gas mileage are noticeable when carburetors and fuel injectors become clogged. Likewise, boiler units also experience similar problems. Boiler units with incomplete combustion not only waste fuel; they substantially pollute the environment; and require costly repairs due to carbon buildup. The present invention creates a harmonic effect that increases bonding between hydrogen and oxygen atoms in fuel. This effect results in a substantially better mixture of fuel and oxygen.

To promote complete combustion of fuel in an engine, oxygen must be combined with a hydrocarbon molecule. Since the net charges of hydrocarbon and oxygen molecules are both negative, repulsive forces not attractive forces exist. These repulsive forces tend to keep the hydrocarbon and oxygen molecules separate. To overcome the repulsive forces, combustion engineers typically design combustion processes so that the combustion envelope is supersaturated with oxygen. The overwhelming oxygen concentration forces the two similarly charged molecules together in close proximity which eventually results in the combination of the two to create a climate conducive to combustion.

The present invention recognizes that fuel may be ionized by an external harmonic influence. In the present invention, hydrocarbons in the fuel are ionized to create a net positive charge. The effect of ionizing the hydrocarbons causes them to aggressively attract and bond with available oxygen, thereby creating a more comprehensive hydrocarbon molecule having its own oxygen supply. The end result is a faster, more efficient and fully burning mixture that has its own oxygen base.

The present invention also polarizes the fuel mixture by replacing normally chaotic fluid with an even, positively charged, uniformly-aligned fuel with which the oxygen bonding results in an almost total burn for complete BTU output and better fuel efficiency. The fuel also attracts and removes previous carbon and varnish build-up in jets, injectors and other engine parts for even higher efficiency. Further, when harmonics are properly applied, in addition to increasing fuel efficiency, diesel fuel will resist gelling. Gelling is temperature induced “crystallization.” This means that during cold weather, special fuel additives may be eliminated. Additionally, in hot weather, algae/microbe problems, associated with diesel use, are practically eliminated when the present invention is used. When the present invention is used, increased energy release in combustion engines typically ranges from 8-25%. Tests have also shown that hydrocarbons and monoxides are drastically reduced. Also, the amount of carbon dioxide released is increased indicating a higher energy release.

Genset Emission Project
Testing the FUELSMART Combustion Enhancer
Aug. 5&6, 1999

| | |
|---|---|
| Location: | Newport News, Virginia |
| Testing Facility: | Air Monitoring Services of Richmond, VA |
| | (US EPA certified) |
| Test Engine: | Detroit Diesel |
| | Gen. set 9.32 lit, 365 hp 8V71T |
| | 60% load, 160 Amperes |

40%H 90%F

| 5 Aug | Run #1 | Run #2 | Run #3 | | |
|---|---|---|---|---|---|
| BEFORE | 3:20 P | 4:40 P | 5:55 P | Average | |
| 02% | 13.543 | 13.7 | 13.68 | 13.64 | |
| CO₂ % | 5.232 | 5.13 | 4.97 | 5.12 | |
| Nox ppm | 974.4 | 994.4 | 995.7 | 998.167 | |
| CO ppm | 87.3 | 90.2 | 92.5 | 90.0 | |
| SO₂ ppm | 11.7 | 13.9 | 15.8 | 13.8 | |
| VOC ppm | 49.1 | 41.6 | 42.6 | 44.43 | |
| 6 Aug | Run #4 | Run #5 | Run #6 | | |
| AFTER | 8:50 A | 10:55 A | 11:55 A | | |
| 02% | 13.87 | 13.80 | 13.69 | 13.76 | +3% |
| CO₂ % | 5.56 | 5.39 | 5.60 | 5.52 | +8% |
| Nox ppm | 967.4 | 968.4 | 1001.1 | 978.9 | −1% |
| CO ppm | 85.0 | 90.7 | 94.5 | 90.6 | +.06% |
| SO₂ ppm | 11.2 | 14.3 | 18.1 | 14.5 | +5% |
| VOC ppm | 39.0 | 39.1 | 39.5 | 39.2 | −12% |

A. Visual differences noted:
1. Test probe. Substantially less carbon coating AFTER tests;
2. Oil pressure increased on run #4; changed filter; returned to normal.
3. Black/gray smoke greatly reduced on the subsequent Friday
B. Smell/odor differences noted:
1. Exhaust fumes much less noxious on Friday.
C. Fuel consumption:
1. 45.5 Gal. Baseline 44.1 AFTER; 3 hours runtime
2. Best results after 500-600 hrs run time;
3. Visual fill on dipstick. 1/32 inch equals .45 gal.

Combustion Analysis
#2 Fuel, Oil-Fired Boiler
Gilbert & Barker
Set up: Burner cleaned on this well-maintained 50+ year old boiler

| | BEFORE | TEST #1 | TEST #2 | TEST #3 |
|---|---|---|---|---|
| Nozzle size: | 1 gph @ 60° | 1 gph @ 60° | 1 gph @ 60° | .85 gph @ |
| 1 gph @60° | | | | 60° |
| Stack temp: | 550° F. | 590° F. | 600° F. | 550° F. |
| CO₂: | 10% | 10% | 10% | 8% |
| Smoke: (HC) | 1% | 1% | Trace | None |
| | (10,000 ppm) | | (2,000 ppm) | Observed |
| Eff.: | 75.5% | 75.5% | 75.5% | 71% |
| Flame: | Orange/gold | Yellow/gold | Yellow/gold | Bright |
| | | | | yellow/ |
| | | | | gold |
| Pattern: | Erratic | Good | Good | Excellent |

RESULTS:
Increased temp. 40-50° Tests #1&2
Reduced CO₂ 2% Test #3
Reduced HC(soot) Tests #2&3
Improved flame characteristics Tests #1,2&3
Reduced nozzle size 15%, which reduced fuel flow 15% Test +1903
Maintained spec. temperature of 550° Test #3
Reduced CO₂ 20% Test #3
Practically eliminated smoke Test #3
Improved flame characteristics substantially Test #3

Table 1 shows the results of an emission test for a generator set. Three tests were conducted without the electronic combustion enhancer, the catalyst and the magnetic unit. The combustion enhancer with the catalyst and the magnetic unit were added and three additional emission tests were conducted. As can be seen in Table 1, the percentages of oxygen, carbon dioxide and sulfur dioxide being emitted from the exhaust of the generator increased with the use of the electronic combustion enhancer, catalyst and magnetic unit. The percentages of nitrogen oxide and VOCs were reduced when the generator set was equipped with the electronic combustion enhancer, catalyst and magnetic unit. While the amount of emitted carbon monoxide remained essentially the same. Fuel consumption was reduced by 5 percent.

Table 2 shows the results of a combustion analysis for an oil-fired boiler. It should be noted that the operating temperature in tests #1 and #2 increased as a result of increased energy release. The test results shown in Table 2 include reduced carbon dioxide when the temperature of the boiler was returned to the manufacturer's specification. Hydrocarbon emissions were reduced in tests #2 and #3 and flame characteristics were increased in all tests performed after the electronic combustion enhancer, catalyst and magnetic unit was installed on the boiler. Visible smoke was significantly reduced in test #3. Carbon dioxide emissions were reduced by 20% in test #3.

The present invention is comprised of an electronic modulated frequency fuel conditioner, a separator, a fuel catalyst, a magnetic ionizer and an engine conditioner. The electronic modulated frequency fuel conditioner reduces the thixotropy of the fuel, thereby de-agglomerating paraffins and asphaltines. The de-agglomerating effect creates a more complete and uniform burning of the fuel.

An object of the present invention is to reduce the amount of pollution released from internal combustion engines by converting long-chain hydrocarbons into short-chain hydrocarbons, thereby releasing less harmful pollutants during engine or boiler operation. Thus, the present invention reduces harmful exhaust emissions such as HC, NOₓ, VOCs, CO and particulate matter.

Another object of the present invention is to reduce foreign bodies in the fuel supply before ignition of the fuel, thus resulting in greater energy output. The reduction of foreign bodies in the fuel supply keeps working engine parts such as plugs, injectors and oil cleaner, thereby reducing maintenance costs and operational down time.

A further object of the present invention is to increase the life of an engine or oil burner by reducing the harmful effects of burning foreign bodies and long-chain hydrocarbons.

The present invention increases the British Thermal Units (BTU) output in a combustion engine thereby causing the engine to work more efficiently. Since the engine works more efficiently, greater energy savings in the form of reduced fuel costs results.

Other realized benefits include: reduced hot spotting; cutting out; missing and stalling; reduced low octane pinging; stabilization of vapor problems; reduced heavy post-ignition; reduced paraffin buildup; and gradual cleaning of carbon buildup in the engines of older cars and trucks.

In the present invention, the electronic combustion enhancer comprises a modulated RF and harmonic frequency generator and a coil. The modulated RF and harmonic frequency generator comprises a microprocessor and a transmitter. In other words, the electronic combustion enhancer comprises: a means for creating a modulated signal; a means for transmitting the modulated signal; and a means for imparting the modulated signal to fuel supplied through a fuel line.

Further the invention comprises a process for enhancing combustion of fuel by generating an oscillating signal and applying the oscillating signal to fuel supplied through a fuel line to ionize the fuel. The method comprises the steps of: removing particulate matter and free water from the fuel; treating the fuel with a catalyst; ionizing the fuel via an electronic combustion enhancer; aligning molecules in the fuel with a properly structured magnet; and reducing internal engine friction with a friction reducing metal conditioner.

In one embodiment of the invention, a method of enhancing combustion of fuel comprises generating an oscillating signal and applying the oscillating signal to fuel supplied through a fuel line to ionize the fuel.

In another embodiment of the invention, a method of treating fuel comprises removing particulate matter and free water from the fuel, treating the fuel with a catalyst, ionizing the fuel via an electronic combustion enhancer, aligning molecules in the fuel with a magnet, and reducing internal engine friction with a friction reducing metal conditioner. This method may also include transferring fuel from a supply tank to a combustion chamber.

A further embodiment of the invention comprises a system for enhancing combustion of fuel that includes a means for removing particulate matter and free water from the fuel, a catalyst means for treating the fuel, a means for ionizing the fuel, a means for aligning molecules in the fuel, and a means for conditioning metal parts that come into contact with the fuel. The catalyst means may comprise dissimilar metal amalgam pellets. The means for ionizing the fuel may comprise a signal generator, oscillator, inductor or coil.

Another embodiment of the invention comprises a fuel supply system including a seperator for removing foreign bodies from the fuel, a catalyst, a fuel conditioner, a magnetic ionizer, and an engine conditioner

An additional embodiment of the invention includes a fuel supply system comprising: a means for transferring fuel from a source to a combustion chamber, an electronic means for producing an alternating signal, and a means for imparting the alternating signal to said fuel. This fuel supply system may further comprise a means for removing particulate mater and free water from the fuel. The system may also include: a catalyst means for treating the fuel, a means for aligning molecules in the fuel such as a magnet, and a means for conditioning metal parts that come into contact with the fuel.

A further embodiment of the invention may include an electronic combustion enhancer comprising: a modulated RF and harmonic frequency generator; and a coil. The electronic combustion enhancer further comprises: a microprocessor; and a transmitter.

In a further embodiment of the invention, an electronic combustion enhancer comprises: a means for creating a modulated signal cycling no less than one thousand times per second between fifty and four thousand Hertz, a means for transmitting the modulated signal, and a means for imparting the modulated signal to fuel supplied through a fuel line to treat a fuel.

### BRIEF DESCRIPTION OF THE DRAWINGS

FIG. 1 is a schematic view of a stationary fuel line equipped with the electronic combustion enhancer.

FIG. 2 is a schematic view of a mobile fuel line equipped with the electronic combustion enhancer.

FIG. 3 is a schematic view of a fuel treatment system comprising the electronic combustion enhancer.

FIG. 4 depicts a separator.

FIG. 5 depicts a fuel catalyst.

FIG. 6 depicts an electronic modulated frequency fuel conditioner.

### DETAILED DESCRIPTION OF THE DRAWINGS

The embodiments of the present invention presented hereinafter are merely exemplary of the invention. The present invention may be embodied in various configurations. It is to be understood that the specific structural and functional details disclosed in the following embodiments are not to be interpreted as limiting, rather they are the basis for the claims and are to be used to teach a skilled artisan of the art how to practice the invention.

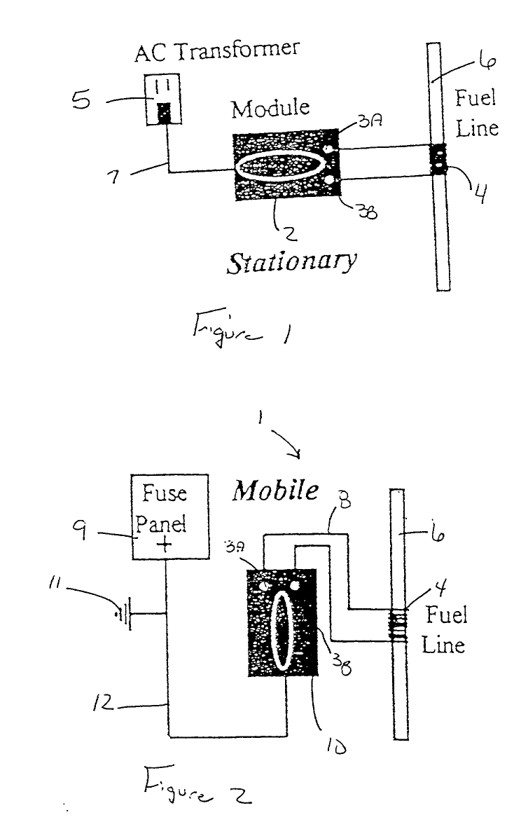

FIG. 1 depicts an electronic combustion enhancer 1 coupled to a fuel line 6 for providing fuel to a stationary engine or open-flame combustor. An alternating current (AC) transformer 5 has a primary winding connected to an AC power source (not shown). The secondary winding of the AC transformer 5 connects to a power input of a modulated RF and harmonic frequency generator and control module 2. Two output terminals 3 are located on the modulated RF and harmonic frequency generator and control module 2 for receiving ends of a coil or fuel line wrap 4. The coil 4 is oriented around a straight section of the fuel supply line 6.

During operation of the fuel supply system, the RF and harmonic frequency generator 2 typically supplies pulses with a frequency of approximately 50-6000 Hz to the coil 4. The coil 4 creates an electro-magnetic-harmonic field in the fuel supply line 6 that causes ionization of long-chain hydrocarbons. The control module 2 causes ionization of the fuel by oscillating the coil 4 at the resonant frequency of all fuel constituencies. The ionization changes the polarity of the long-chain hydrocarbons causing them to attract oxygen molecules. The combination of imparted harmonics, catalysis and electromagnetism overcomes the thixotropy of the long-chain hydrocarbons.

In the preferred embodiment, a power cable 7 for the control module 2 has a wall plug transformer 5 that is connected to a standard 110-volt wall receptacle (not shown). The control module 2 is positioned or mounted within two feet of the location of the fuel line wrap 4. Velcro tape (not shown) is used to secure the control module 2. One end of a signal cable is inserted into a signal port 3A on the control module 2. A straight section of fuel supply line 6 is located. The signal cable 8 is fastened to the straight section by a first cable tie (not shown). The signal cable is then wrapped in a snugly close coil formation for a distance of approximately 7″. A second cable tie (not shown) is used to secure the last wrap of the signal wire 8. The loose end of the signal cable 8 is then inserted into the remaining signal port on the control module 2.

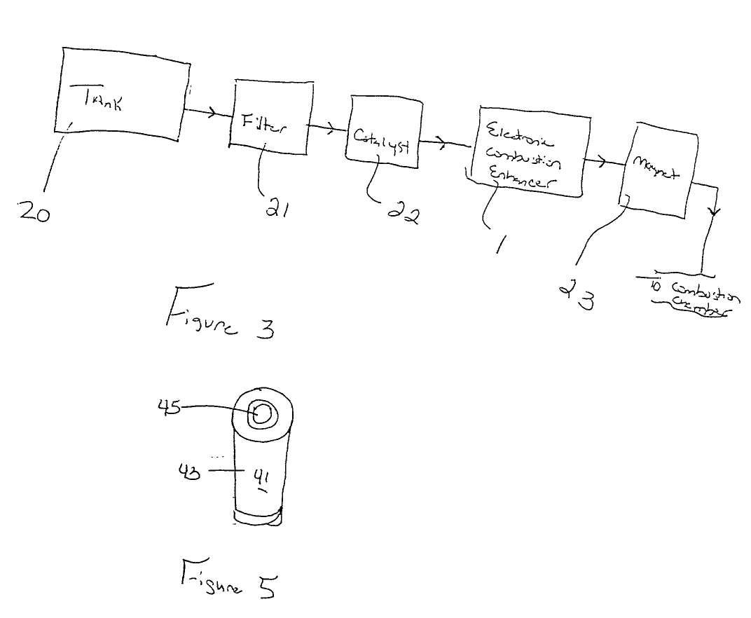

FIG. 2 depicts an electronic combustion enhancer 1 coupled to a fuel line 6 for providing fuel to a mobile engine. The RF and harmonic frequency generator and control module 2 has a power connection lead 10 that is connected with a fuse panel (+) 9 and ground (−) 11. Two output terminals 3 are located on the modulated RF and harmonic frequency generator and control module 2 for receiving ends of a coil 4. The coil 4 is oriented around a straight section of the fuel supply line 6. In this configuration, the RF and harmonic frequency generator and control module 2 is designed to accept either a 12 or 24 volt power supply signal.

In the preferred embodiment for a mobile engine, the negative (−) terminal of battery supply source (not shown) is disconnected prior to installation of the electronic combustion enhancer 1. The mounting location of the control module 2 and signal wire 8 is the same as mentioned above with respect to the stationary embodiment. The control module 2 is positioned as high as possible from the roadway surface with the power supply port (not shown) on the bottom. A transformer 5 is unnecessary for the mobile embodiment. The power cable 10 connects to the available power source (typically the output side of the fuse panel 9 marked “accessories”). One power lead connects to power 9 and the other power lead connects to ground 11.

FIG. 3 depicts a fuel combustion enhancer system comprising an enhance 1 as shown in either FIG. 1 or 2. Fuel drawn from fuel tank 20 flows through filter 21. The filter 21 removes particulate matter and free water from the fuel. Next, a catalyst 22 catalyzes the fuel. The electronic combustion enhancer 1 then ionizes the fuel. The fuel next passes through a portion of the fuel line that is surrounded by a magnet 23, such as a rare-earth type. At this stage, the molecules of the fuel align. In the preferred embodiment, magnet 23 is a bar magnet having the proper pole located next to the fuel line. Using a friction reducing metal conditioner reduces internal engine friction. This system provides enhanced performance and increased energy output.

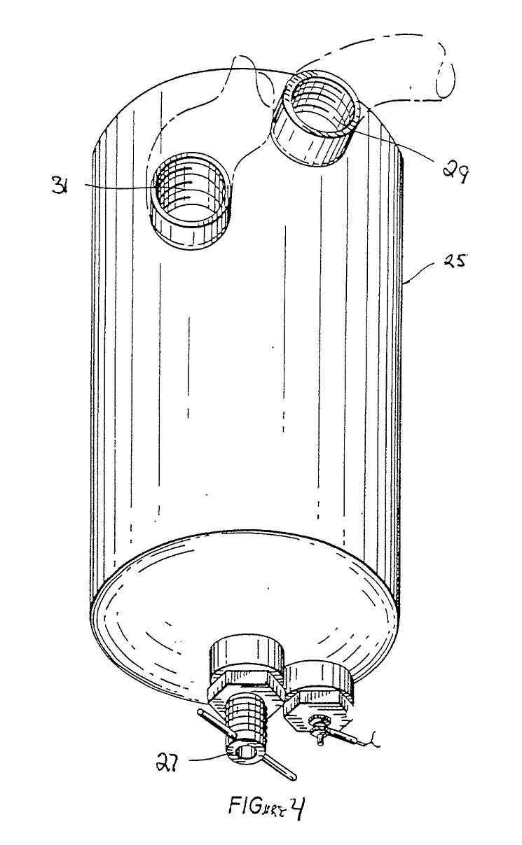

FIG. 4 depicts a fuel separator or filter 25. The fuel separator 25 removes free water and contaminates from the fuel. The separator 25 is equipped with a drain cock 27 for draining the free water and contaminates from the fuel system. The fuel separator 25 comprises a fuel intake orifice 29 and a fuel exit orifice 31. Fuel is routed through the separator 25 and contaminates are removed.

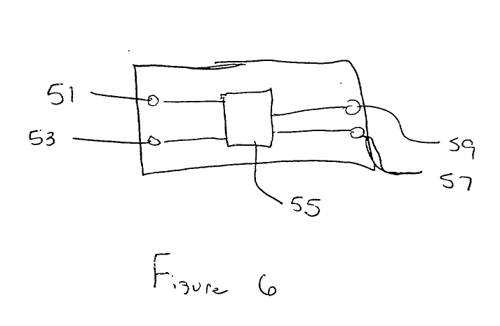

FIG. 5 depicts a fuel catalyst. The fuel catalyst 41 comprised of a casing 43 enclosing several different types of non-precious metals. In the preferred embodiment the fuel catalyst 41 comprises five to seven different types of dissimilar metal amalgam pellets (not shown). The fuel catalyst 41 also includes and intake orifice 45 located at an end of the catalyst 41 opposite the fuel exit orifice (not shown).

FIG. 6 depicts an electronic combustion enhancer 1. The enhancer 1 includes power source input terminal 51 and ground terminal 53. Control circuitry 55 for generating a modulated signal connects to terminals 51 and 53. Control circuitry 55 modulatesan output signal within a predetermined frequency range, as discussed above. The enhancer 1 also includes signal output terminals 57 and 59 for transmitting the modulated signal through a coil 4 to impart the signal to the fuel. Control circuitry 55 may comprise a microprocessor or a simple R-L-C oscillating circuit.

Several combinations of the present invention can provide elimination of thixotrophic problems associated with water and other fluids to reduce scale of calcium, lime and other minerals on pipe walls that inhibit flow and interferes with efficient production.

It is to be understood that the invention is not limited to the exact construction illustrated and described above, but that various changes and modifications may be made without departing from the spirit and the scope of the invention as defined in the following claims.

I claim:

1. A method of enhancing combustion of fuel comprising:
generating an oscillating signal; and
applying the oscillating signal to fuel supplied through a fuel line to interfere with the thioxotropy of the fuel and de-agglomerate parafins, asphaltines and other long chain hydrocarbons present in the fuel.

2. A method of treating fuel comprising:
removing particulate matter and free water from the fuel;
treating the fuel with a catalyst;
ionizing the fuel via an electronic combustion enhancer;
aligning molecules in the fuel with a magnet; and
reducing internal engine friction with a friction reducing metal conditioner.

3. The method of claim 2 further comprising:
transferring fuel from a supply tank to a combustion chamber.

4. A system for enhancing combustion of fuel comprising:
means for removing particulate matter and free water from the fuel;
catalyst means for treating the fuel;
means for ionizing the fuel;
means for aligning molecules in the fuel with a magnet;
means for conditioning metal parts that encounter the fuel.

5. A fuel supply system comprising:
a seperator for removing foreign bodies from the fuel;
a catalyst;
a fuel conditioner;
a magnetic ionizer; and
an engine conditioner.

6. A fuel supply system comprising:
means for transferring fuel from a source to a combustion chamber;
electronic means for producing an alternating signal;
means for imparting said alternating signal to said fuel;

7. The fuel supply system of claim 6 further comprising:
means for removing particulate matter and free water from the fuel.

8. The fuel supply system of claim 6 further comprising:
catalyst means for treating the fuel.

9. The fuel supply system of claim 6 further comprising:
means for aligning molecules in the fuel with a magnet.

10. The fuel supply system of claim 6 further comprising:
means for conditioning metal parts that come into contact with the fuel during the combustion process.

11. An electronic combustion enhancer comprising:
a modulated RF and harmonic frequency generator; and
a coil.

12. The electronic combustion enhancer of claim 11 further comprising:
a microprocessor; and
a transmitter.

13. An electronic combustion enhancer comprising:
a means for creating a modulated signal;
a means for transmitting the modulated signal; and
a means for imparting the modulated signal to fuel supplied through a fuel line to treat a fuel.

14. A method of conditioning fuel prior to combustion, comprising:
moving fuel from a fuel reservoir to a combustion chamber; and
agitating said fuel by transmitting a modulated electromagnetic signal through said fuel.

15. A method of conditioning fuel prior to combustion comprising:
moving fuel from a reservoir to a combustion chamber;
agitating said fuel by transmitting an electromagnetic signal through said fuel; and,
moving said fuel through a magnetic field of 10,000 Gauss fuel to align molecules in said fuel for more complete combustion of the fuel.
